(19) United States
(12) Patent Application Publication
(10) Pub. No.: US 2004/0212629 A1
(43) Pub. Date: Oct. 28, 2004

(54) Drawing processing apparatus, drawing processing method, drawing processing program and teleconference system equipped therewith

(75) Inventor: Tomoki Ohkawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/829,276

(22) Filed: Apr. 22, 2004

(30) Foreign Application Priority Data
Apr. 25, 2003 (JP) P.2003-122406

(51) Int. Cl. G09G 5/00

(52) U.S. Cl. 345/629

(57) ABSTRACT

A drawing processing apparatus has an image control section for cutting out a moving image from the moving image every predetermined time and extracting input drawing static information from a drawn input image every the predetermined time, an image information storage section for holding input drawing static image data and static image data in a moving image cut out by the image control section, an image combining section for combining the static image data in a moving image and the input drawing static data held in the image information storage section to create combined image data, and an image drawing section for continuously outputting the combined image data. Therefore, it is possible to balance a capture of an image and a writing on a moving image inside a screen used in a teleconference etc.

### BACKGROUND OF THE INVENTION

1. Field of the Invention

The present invention relates to a drawing processing apparatus, a drawing processing method, a drawing processing program and a teleconference system equipped therewith.

2. Description of the Related Art

In recent years, process of a moving image by using a general-purpose PC has become general as broadband environment spreads and performance of a PC (personal computer) improves. For example, in a teleconference system etc., the following method is known as a drawing processing method in which a symbol, an arrow, a character, any writing, etc. on the display screen are added by a drawing input device etc. to superimpose upon a moving image when the moving image is displayed on a display screen outputted from a general-purpose PC.

In a general-purpose PC in which an OS (operating system) such as Windows (registered trademark) is used, a drawing processing method for superimposing drawn static images upon a moving image on a display screen to display a superimposed image is used. A drawing processing method in which a graphics accelerator is used is explained below.

FIG. 1 is a diagram showing a conventional drawing processing apparatus 200 in which a graphics accelerator is used on an OS of a general-purpose PC. As shown in FIG. 1, a moving image which a user selects from among moving image data stored in a mass recording medium 211 is sent to a moving image reproducing section 212. Then, drawing processing is performed by a hardware drawing section 213 of the graphics accelerator to display the selected moving image on a screen display device 216. On the other hand, input drawing data which a user inputs by using a drawing input device 214 is processed in an image drawing section 215 to display on the screen display device 216 concurrently with the moving image.

As a result, as shown in FIG. 2, it can be seen that a moving image A (moving image of a flying bird) obtained by performing the hardware drawing in the graphics accelerator and an input drawing image (arrow) B processed by the image drawing section 215 on the OS independently of this moving image are overlapped on a display screen of the screen display device 216.

As a method in which a user is interactively associated when a moving image is displayed on a display screen, for example, a technique for combining moving image data with static image data previously stored according to input of the user, described in JP-A-7-306953, is known.

JP-A-7-306953 is referred as a related art.

In the conventional drawing processing apparatus described above, it is impossible to capture a moving image displayed on the screen display device 216 into a clipboard (memory). This is because a screen capture which is a portion of functions of the OS cannot be performed since the OS does not directly control the hardware drawing section 213 as the graphics accelerator.

Therefore, when a screen capture function of the OS is utilized, as shown in FIG. 3, the screen capture is performed in the image drawing section 215 directly managed by the OS, and only input drawing data is captured in the clipboard. Thus, on a screen captured in the clipboard, only the input drawing image (arrow) B is displayed on a black screen in which moving image data is not present, as shown in FIG. 4.

On the other hand, in a conventional drawing processing apparatus 200A of the case that setting of an OS is changed and drawing (writing) is performed on a moving image without using a graphics accelerator, as shown in FIG. 5, an image drawing section 215A which is directly controlled by the OS manages input drawing data and moving image data. As a result, screen capture of a moving image can be performed.

However, in this case, as shown in FIG. 6, since moving image data (a1, a2, a3, . . . ) are successively sent to the image drawing section 215A, input drawing data sent to the image drawing section 215A is overwritten by the moving image data (because exclusive control by the OS is not performed) and the input drawing data is overwritten and deleted.

As explained above, in the conventional drawing processing apparatus, a function in which when a moving image is displayed on a display screen, a user writes a symbol, an arrow, a character, any writing, etc. on the display screen by a drawing input device etc. to combine the symbol etc. with the moving image and displays in real time could not be balanced with a function in which the combined image is captured to be retained in a storage medium etc. and is displayed later.

In a teleconference system etc., while a user writes a symbol, an arrow, a character, any writing, etc. by a drawing input device etc. rather than static image data stored previously, the user combines this input drawing data with a moving image. Thus, even in the case of applying a conventional combining technique (for example, JP-A-7-306953) for combining a static image with a moving image, processing capability is limited in a general-purpose PC, so that frame omission etc. occur. Therefore, it is difficult to perform smooth display of a moving image.

Although it is considered that input drawing data is overwritten and drawn repeatedly on a moving image, the input drawing data is not continuous due to disappearance or output and an image becomes difficult to see due to flicker. Also, since it is necessary to repeat drawing of the input drawing data at high speed according to a change in moving images, processing of the PC becomes an overload.

Otherwise, it is considered that a window is created by a shape of a path of a pen with which an input drawing image is drawn and writing on its moving image is performed. Thus, although a window object can be displayed on the moving image by a management function of an OS, processing for forming the window by the pen path becomes an overload. In addition, the input drawing image breaks when the window forming processing does not catch up with the drawing.

### SUMMARY OF THE INVENTION

As objects that the invention is to solve, a problem that a function in which a user writes a symbol, an arrow, a character, any writing, etc. on the display screen generated in the conventional art described above by a drawing input device etc. to combine the symbol etc. with a moving image and displays in real time cannot be balanced with a function in which the combined image is captured to be retained in a storage medium etc. and is displayed later is given as one example.

The invention provides a drawing processing apparatus having an image control section for cutting out a moving image as static image information in the moving image every predetermined time and extracting input drawing static information from a drawn input image every the predetermined time, an image information storage section for storing the static image information in the moving image cut out by the image control section and the input drawing static information extracted by the image control section, an image combining section for combining the static image information in the moving image and the input drawing static information stored in the image information storage section to create combined image information, and an image drawing section for continuously outputting the combined image information.

The invention also provides a drawing processing method having the steps of cutting out an image as static image information in a moving image from the moving image, extracting input drawing static information from a drawn input image, combining the static image information in the moving image obtained by the cutout and the input drawing static information obtained by the extraction to create combined image information, and outputting the combined image information, wherein the cutout of the static image information in the moving image and the extraction of the input drawing static information are repeated every predetermined time.

The invention provides a drawing processing program, causing a computer to perform an image control function of cutting out an image as static image information in a moving image from the moving image every predetermined time and extracting input drawing static information from a drawn input image every the predetermined time, and an image combining function of combining the static image information in the moving image cut out by the image control function and the input drawing static information extracted by the image control function to create combined image information.

The invention provides a teleconference system, in which a plurality of participant terminals which participate in a conference are connected through a communication line, wherein a drawing processing apparatus having an image control section for cutting out an image as static image information in a moving image from the moving image every predetermined time and extracting input drawing static information from a drawn input image every the predetermined time, an image information storage section for storing the static image information in the moving image cut out by the image control section and the input drawing static information extracted by the image control section, an image combining section for combining the static image information in the moving image and the input drawing static information stored in the image information storage section to create combined image information, and an image drawing section for continuously outputting the combined image information, is used as the participant terminal.

### BRIEF DESCRIPTION OF THE DRAWINGS

FIG. 1 is a diagram showing a configuration of a conventional drawing processing apparatus;

FIG. 2 is a diagram showing a drawing image by the conventional drawing processing apparatus using an accelerator;

FIG. 3 is a diagram showing another configuration example of a conventional drawing processing apparatus;

FIG. 4 is a diagram showing a result of image capture by the drawing processing apparatus shown in FIG. 3;

FIG. 5 is a diagram showing another configuration example of a conventional drawing processing apparatus;

FIG. 6 is a diagram showing a drawing image by the conventional drawing processing apparatus without using an accelerator;

FIG. 7 is a diagram showing a configuration of a drawing processing apparatus in an embodiment of the invention;

FIG. 8 is a diagram showing a drawing image by drawing processing to a moving image according to the invention;

FIG. 9 is a flowchart showing a drawing processing procedure according to the invention;

FIG. 10 is a diagram describing one example of a configuration of drawing data;

FIG. 11 is a flowchart showing one example of a combining method of input drawing static data and moving image inside static image data;

FIGS. 12A to 12C are examples of a combined image by the combining method of FIG. 11;

FIG. 13 is a flowchart showing details of a cutout step of static image data in a moving image in FIG. 9; and

FIG. 14 is a flowchart showing details of an extraction step of input drawing static data in FIG. 9.

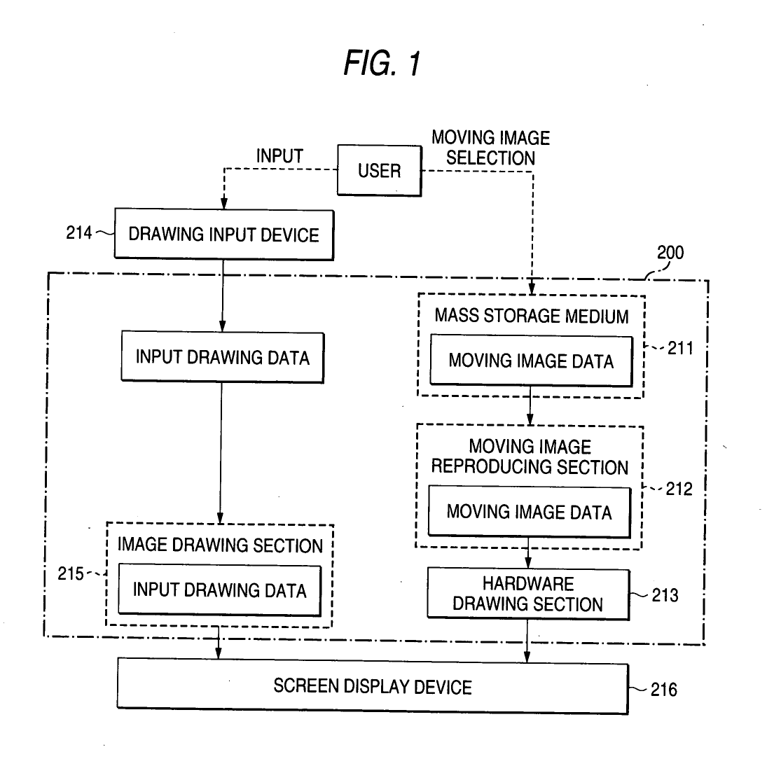

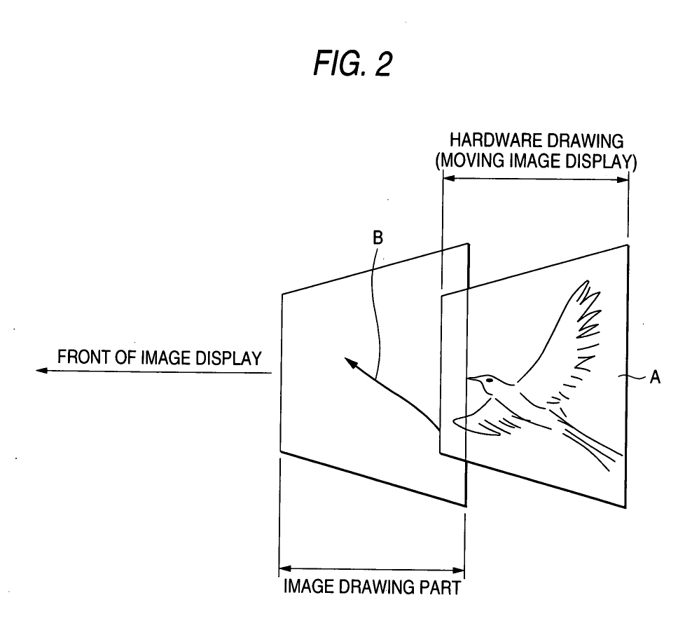

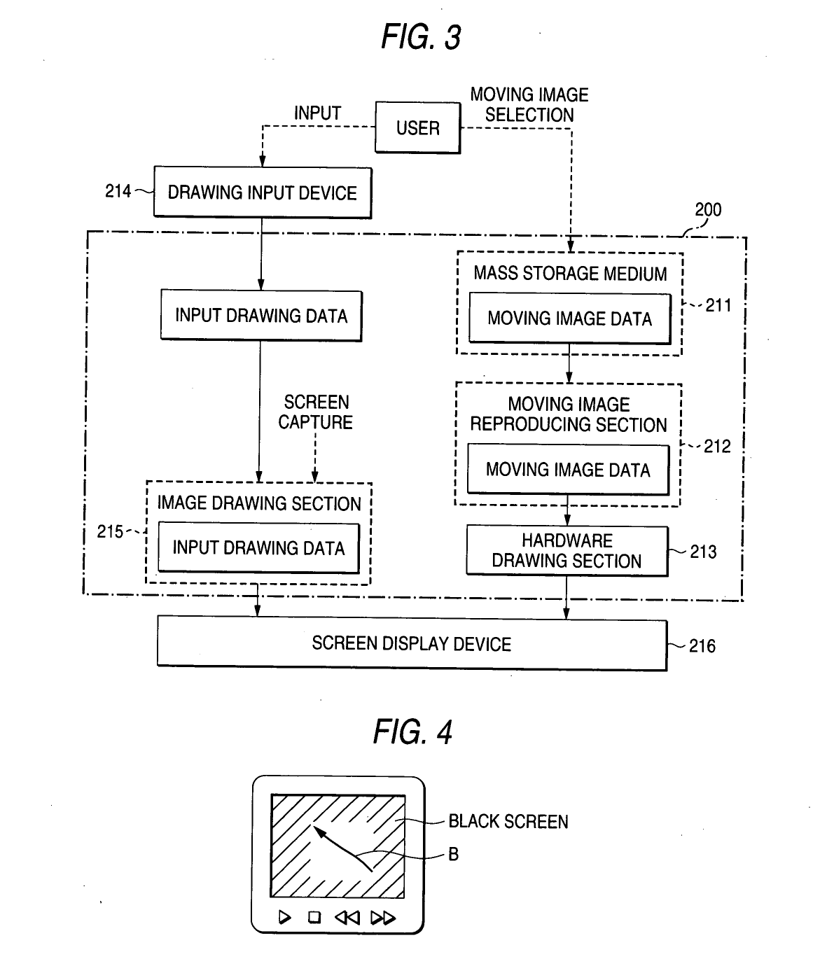

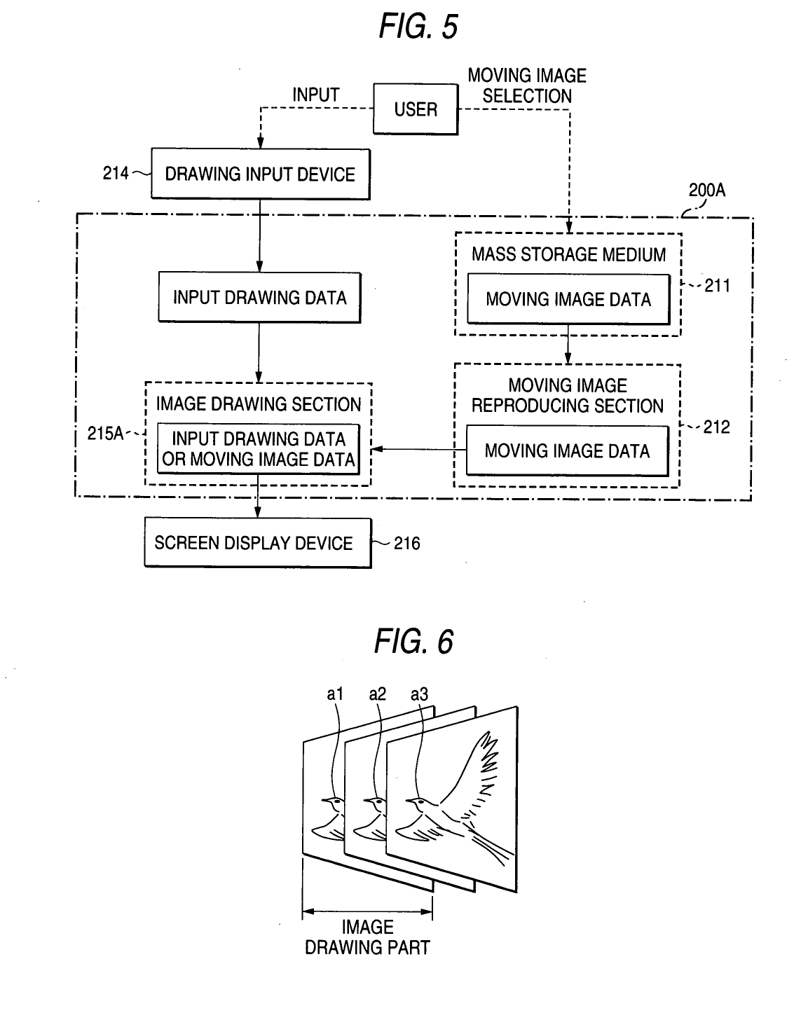

### DETAILED DESCRIPTION OF THE PREFERRED EMBODIMENTS

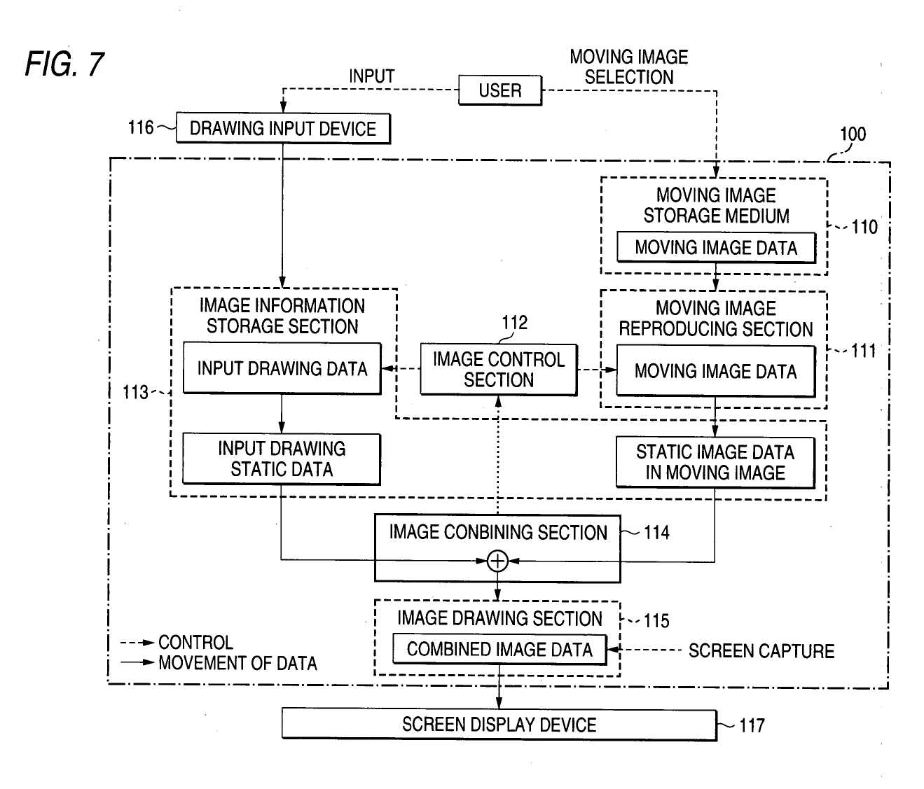

An embodiment of the invention will be described below in detail with reference to FIGS. 7 to 11. FIG. 7 is a diagram showing a drawing processing apparatus according to the embodiment of the invention.

The drawing processing apparatus according to the embodiment of the invention is used in, for example, a teleconference system configured by connecting a plurality of participant terminals which are used in a conference through a communication line.

As shown in FIG. 7, a drawing processing apparatus 100 shows a configuration for data processing, and has a moving image storage section 110 for storing moving image data, a moving image reproducing section 111, an image control section 112, an image information storage section 113, an image combining section 114 and an image drawing section 115. A drawing input device 116 and a screen display device 117 are connected to the outside of the drawing processing apparatus 100. In the drawing processing apparatus 100, a flow of data is shown by arrows of solid lines and a flow of control signals is shown by arrows of dotted lines.

The drawing processing apparatus 100 has the so-called teleconference function and can also handle business applications such as a spreadsheet, a word processor and a presentation. The screen display device 117 of the drawing processing apparatus 100 functions as a whiteboard and data of applications or data written in the whiteboard is shared between a plurality of drawing processing apparatuses 100 and a conference can be given with the same contents displayed in these apparatuses. The drawing processing apparatus 100 is configured by a general-purpose personal computer.

The moving image storage section 110 is configured, for example, by a hard disk or a magneto-optical recording medium which is a mass storage medium. Plural moving image data used in a teleconference etc. is stored therein by an image compression method such as MPEG2, for example, by encoding. Moving image data which a user selects from among the plural moving image data as necessary can be read to the moving image reproducing section 111.

The moving image reproducing section 111 converts the moving image data selectively read from the moving image storage section 110 into reproducible data, for example, by decoding. Display in a form capable of perceiving the moving image data is not performed in the moving image reproducing section 111.

The image control section 112 cuts out the moving image data captured to the moving image reproducing section 111 every time ΔT, and outputs the moving image data as static image data.

The drawing input device 116 inputs data which a user draws by, for example, a fingertip or an electronic pen. This input data may be a point or a line, or drawing data in which these point and line are combined, and further text data. The image information storage section 113 is configured by, for example, a storage medium such as semiconductor memory. The image information storage section 113 stores the drawing data as input drawing data, and the image control section 112 extracts the input drawing data every time ΔT. The extracted drawing data is stored in an area where is different from a storage area of the static image data in a moving image in the image information storage section 113 as input drawing static image data.

The image combining section 114 functions so as to combine the static image data in the moving image stored in the image information storage section 113 with the input drawing static data, and create combined image data as one frame forming a moving image in a pseudo manner.

The image drawing section 115 continuously outputs the combined image data of a frame unit to the screen display device 117 and thereby, a pseudo moving image in which the input drawing data is written is displayed on the screen display device 117.

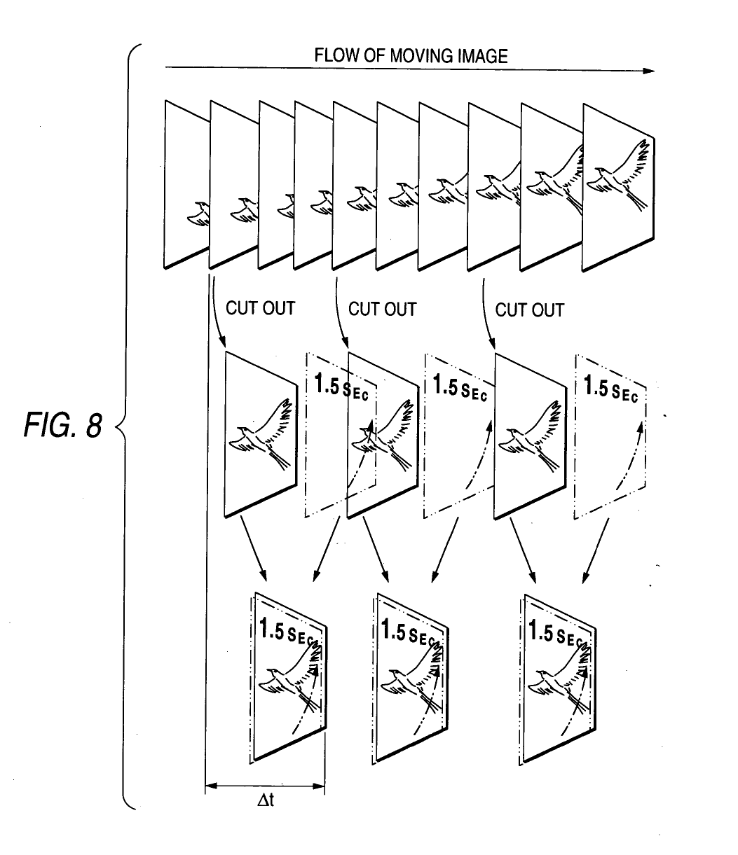

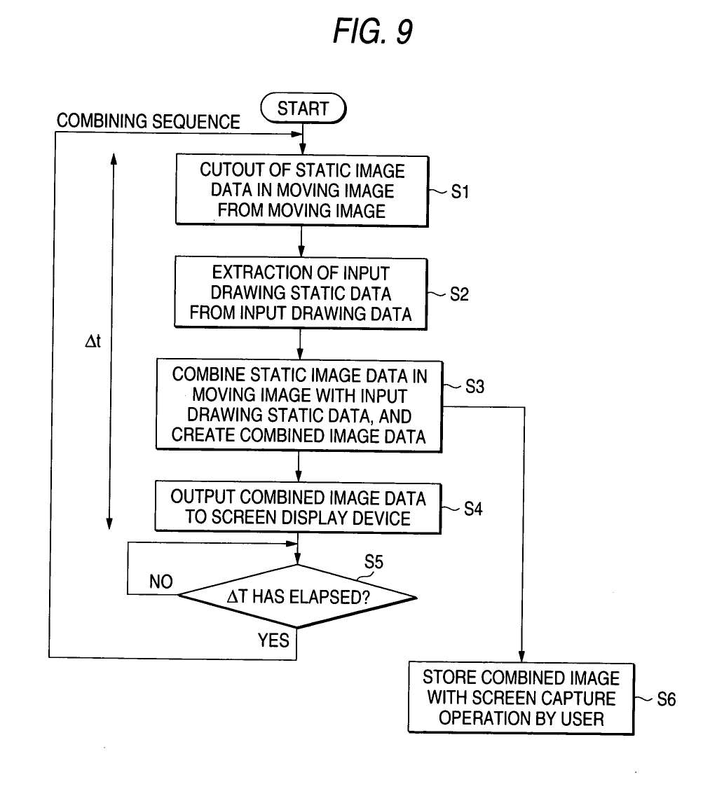

Next, a drawing processing method using the drawing processing apparatus according to the embodiment of the invention will be explained with reference to an explanatory diagram showing a flow of image combining processing shown in FIG. 8 and a flowchart shown in FIG. 9.

First, a user selects moving image data required for a teleconference from the moving image storage section 110. The moving image data selected is converted into reproducible data, for example, by decoding. In the moving image reproducing section 111, a moving image is not displayed on the screen display device 117. On the other hand, input drawing data which the user inputs from the drawing input device 116 is once captured and stored in the image information storage section 113.

Subsequently, as shown in FIG. 9, in order to combine a moving image with input drawing, moving image data on the moving image reproducing section 111 is cut out every predetermined time ΔT by a cutout control signal outputted by the image control section 112 (step S1). Input drawing static data is extracted from input drawing data on the image information storage section 113 every time ΔT by the cutout control signal (step S2).

The moving image data which is cut out and the input drawing static data which is extracted are stored as static image data in an moving image and input drawing static data in the image information storage section 113, and are read to overlap each of these data at predetermined timing by the image combining section 114, and combined image data is created (combined image creation step S3). Then, the combined image data is outputted to the screen display device 117 (image output step S4).

Then, it is decided whether the time ΔT or longer has elapsed or not with respect to time Δt taken to perform screen display of the combined image data outputted in the image output step S4 after performing cutout processing of the moving image and the drawn input image through the image cutout steps S1 and S2 (step S5). If the time At has not elapsed the time ΔT, the processing is waited. If the time At has elapsed the time ΔT, the processing subsequent to the step S1 described above is repeated.

In this manner, the combined image data is outputted, the processing is waited for the time ΔT to elapse, and the processing subsequent to the step S1 is again performed repeatedly at high speed. Therefore, a moving image can be formed in a pseudo manner, and writing of the input drawing data on the moving image can be implemented.

Thus, as an interval of the time ΔT is set to be slightly longer than or equal to time (Δt) taken to perform screen display after performing cutout processing of the image, a load can be prevented from being applied to a general-purpose PC more than necessary.

As a result, parallel processing with writing of the drawing and the processing by the general-purpose PC can be performed smoothly. Since the cutout of an image is performed in real time at the time of reproduction of the moving image data or the input drawing data on the real time axis, a deviation from sound also falls within the At substantially.

When processing time necessary for the cutout etc. of the static image data in a moving image increases, display interval time ΔT of the screen becomes long. However, since cutout time of the static image data in a moving image also shifts with the delay, a situation in which a deviation from sound is gradually increasing while producing the moving image does not occur.

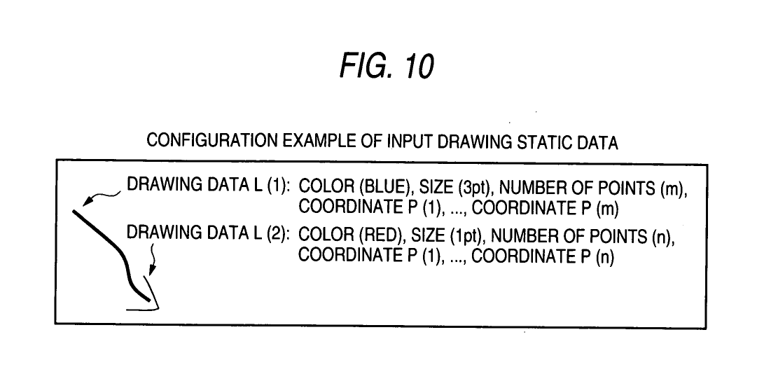

Next, one example of the image combining processing in the drawing processing method mentioned above will be specifically explained with reference to FIGS. 10 to 12.

Input drawing static data is held as a set of drawing data represented in a vector format configured by including color, size, the number of points, a coordinate data set and so on. For example, the input drawing static data shown in FIG. 10 is configured by drawing data L(1) and drawing data L(2). In the drawing data L(1), color is blue, size is 3 pt, the number of points is m, and a coordinate data set includes coordinates P(1) to P(m). In the drawing data L(2), color is red, size is 1 pt, the number of points is n, and a coordinate data set includes coordinates P(1) to P(n). Points forming the drawing data L(1) or L(2) are acquired every event that a mouse has moved at the time of input drawing by a pointing device such as a mouse.

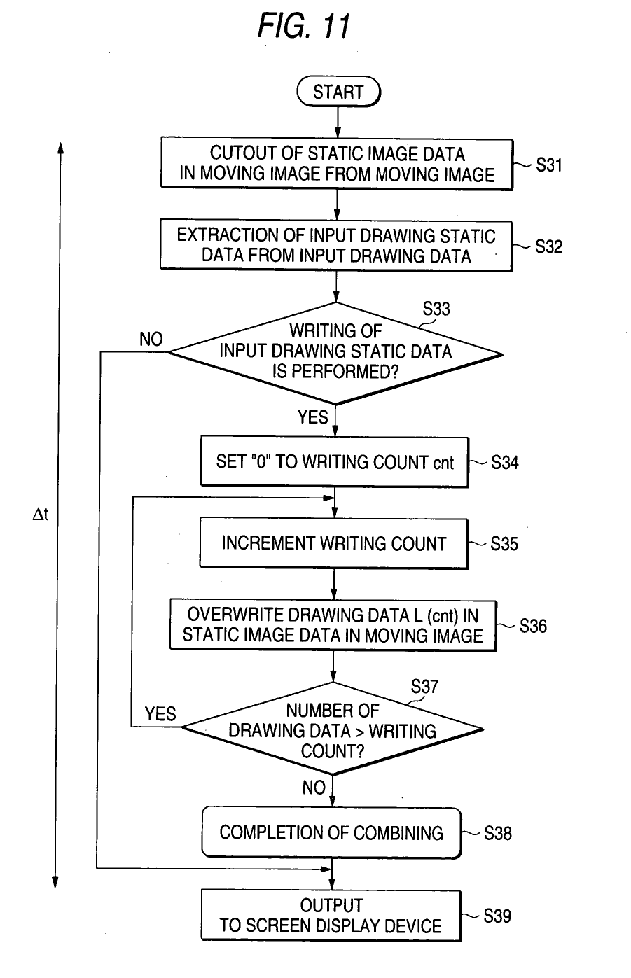

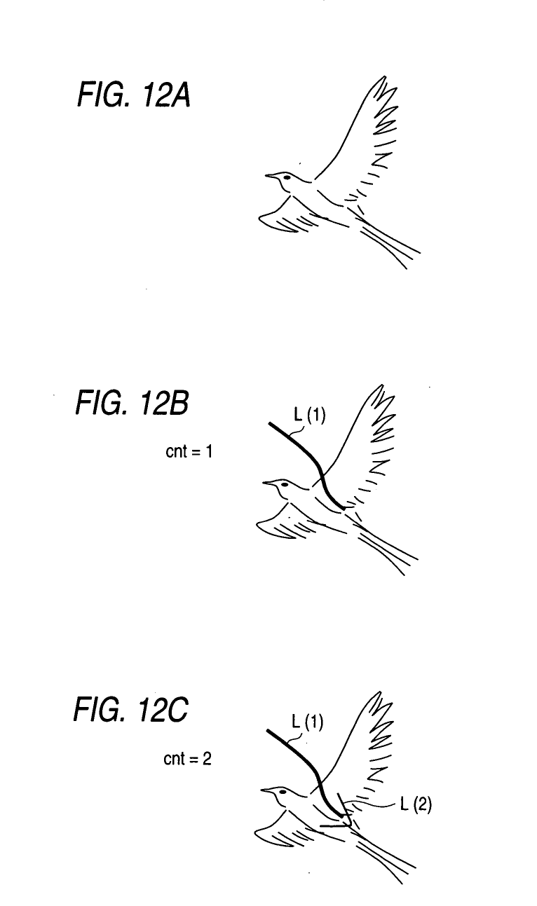

Then, combination with the static image data in a moving image stored in the image information storage section 113 is performed by writing the drawing data of the input drawing static data on the static image data in a moving image stored in the image information storage section 113. Description will be made below with reference to a flowchart of FIG. 11 and one example of combined images of FIGS. 12A to 12C.

First, static image data in a moving image is cut out by the moving image reproducing section 111 (step S31, see FIG. 12A). Also, input drawing static data is extracted from input drawing data stored in the image information storage section 113 (step S32). Next, whether or not writing is performed in this input drawing static data is judged (step S33). When the writing is not performed, the static image data in a moving image is outputted to the screen display device as it is (step 39).

On the other hand, when the writing is performed, “0” is first set to a writing count cnt (step S34). Next, this writing count cnt is incremented (addition of “1”) (step S35), then drawing data L (cnt) is overwritten in the static image data in a moving image (step S36, see FIG. 12B of a combined image for cnt=1).

Then, the writing count cnt is compared with the number of drawing data (step S37). When the writing count cnt is more than or equal to the drawing data, that is, when all the drawing data (L(1), L(2)) is overwritten in the static image data in a moving image (see FIG. 12C of a combined image for cnt=2), combining processing is completed (step S38). Then, this data of the combined image of FIG. 12C is outputted to the screen display device (step S39).

As a method for overwriting the drawing data described above in the static image data in a moving image, the drawing data may be mixed with the static image data in a moving image at an arbitrary ratio by translucent processing such as α blending rather than full overwriting.

Thus, according to the combining method described above, since the input drawing static data is held as a set of the drawing data, combining time relates to the amount of drawing data forming the input drawing static data regardless of screen size.

As a result, when the amount of drawing data forming the input drawing static data is small, processing time At taken to combine an image is also short. Therefore, more combined images can be displayed on a screen and a moving image can be shown more smoothly.

However, when the amount of drawing data forming the input drawing static data increases, a count of overwriting to the static image data in a moving image stored in a memory increases to result in an increase in processing time Δt necessary for combining time.

However, it is rare to perform input drawing so much that a moving image of a background is invisible in a situation of writing on a moving image. Since a tendency to suppress the amount of drawing data forming the input drawing static data to a small amount is had, a demerit that processing time Δt necessary for combining time increases with an increase in the amount of drawing data presents no problem substantially.

In the embodiment of the image combining processing described above, although the input drawing static data is a set of drawing data represented in a vector format, the format may be a bitmap format.

When the data of the bitmap format is combined with the static image data in a moving image, it is necessary to perform comparison calculation for respectively determining whether or not overwriting is performed with respect to all the pixels forming an image. Then, in the pixel determined that the overwriting is performed, overwriting processing is performed by the same color as that of a pixel of corresponding coordinates in the static image data in a moving image.

Since the number of pixels increases when screen size becomes large, combining processing time Δt including determination processing at the time of combining increases.

According to the embodiment, as described above, since moving image data and input drawing data are not on the same layer, these data can be held individually. Therefore, as an image after screen capture can be handled as two layers of background video and an input image, the range of uses increases. For example, it can also be configured that only input drawing data can be deleted from a combined image captured.

In the above, although an example of performing drawing in moving image data prepared previously has been shown, live video captured from a video camera can also be used as a source of moving image data.

Since combined image data obtained in the image drawing section 115 is a pseudo moving image in which static images are continuous as described above, the combined image data can be captured by input of a screen capture signal with a screen capture operation by a user (step S6). Therefore, when a plurality of drawing processing apparatuses for participating in a teleconference are connected through a communication line as participant terminals, information interchange can be performed interactively inside a setting screen on a PC screen while performing capture of an image or writing of drawing data in a moving image used in the conference.

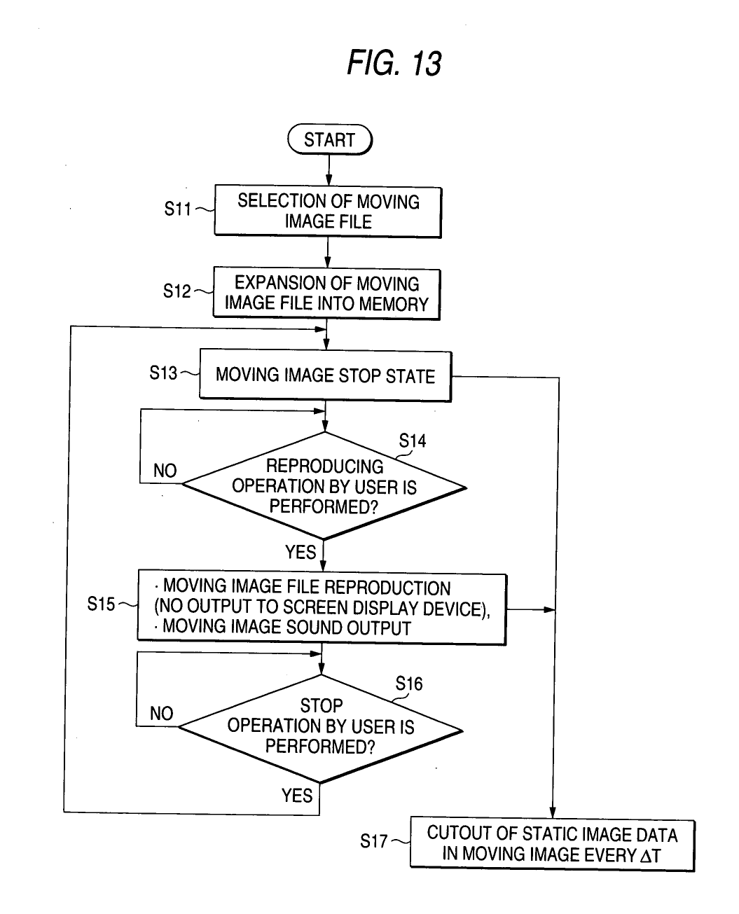

FIG. 13 is a flowchart showing details of a cutout step of static image data in a moving image (step S1) of FIG. 9. In the cutout of the static image data in a moving image, when a user first selects a moving image file (step S11), memory expansion of the selected moving image file is performed (step S12) and moving image data is stopped in a frame unit (step S13).

Next, the processing is waited for a reproducing operation of the moving image data by the user. When the reproducing operation is performed, the moving image file is reproduced (step S15). This reproduced image is not outputted to the screen display device 117. However, sound of the moving image is outputted. Then, the processing is waited for a stop operation by the user, and when the stop operation is performed, the processing subsequent to the step S13 is repeatedly performed again (step S16). In the moving image stop state (step S13) and the reproducing state (step S15) of the moving image file, the static image data in a moving image is cut out every time ΔT (step S17).

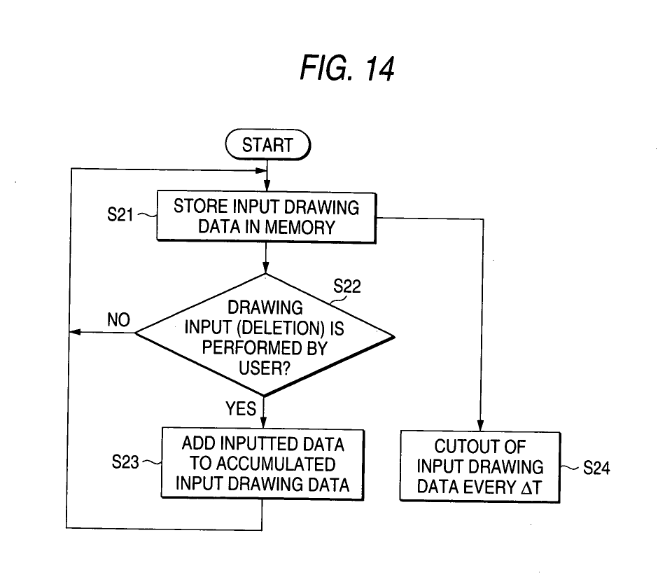

FIG. 14 is a flowchart showing details of an extraction step of input drawing static data (step S2) of FIG. 9. In the extraction of this input drawing static data, input drawing data is first stored in the image information storage section 113 (step S21). When input (deletion) of drawing by a user is performed (step S22), inputted drawing data is added to the input drawing data accumulated (step S23). The input drawing data stored in memory in step S21 is cut out every time ΔT (step S24).

Thus, by rapidly repeating that a screen is cut out of the moving image at regular intervals without displaying a moving image and drawing data is combined thereon to display the combined image, a moving image is created in a pseudo manner to display this moving image.

Since screen data is captured to an OS once, capture of a screen from this screen data can also be implemented smoothly. Therefore, in a teleconference system etc., since a state of a moving image can be perceived while writing information, a presentation can be supported effectively.

As described in detail above, the drawing processing apparatus 100 according to the embodiment has an image control section 112 for cutting out an image as static image information in a moving image from the moving image every predetermined time and extracting input drawing static information from a drawn input image every the predetermined time, an image information storage section 113 for storing the static image data in the moving image cut out by the image control section 112 and the input drawing static information extracted by the image control section 112, an image combining section 114 for combining the static image information in the moving image and the input drawing static information stored in the image information storage section 113 to create combined image information, and an image drawing section 115 for continuously outputting the combined image information.

The drawing processing method according to the embodiment has an image cutout step S1 of cutting out an image as static image information in a moving image from the moving image, an image extraction step S2 of extracting input drawing static information from a drawn input image, a combined image creation step S3 of combining the static image information in the moving image obtained by the cutout and the input drawing static information obtained by the extraction to create combined image information, and an image output step S4 of outputting the combined image information, wherein the cutout of the static image information in the moving image and the extraction of the input drawing static information are repeated every predetermined time.

The drawing processing program according to the embodiment, causes a computer to perform an image control function of cutting out an image as static image information in a moving image from the moving image every predetermined time and extracting input drawing static information from a drawn input image every the predetermined time, and an image combining function of combining the static image information in the moving image cut out by the image control function and the input drawing static information extracted by the image control function to create combined image information.

The teleconference system is configured by using the drawing processing apparatus 100 as participant terminal for participating in a conference.

Thus, due to repeating actions in which a screen is cut out of a moving image every predetermined time and drawing data is combined thereon to display the combined moving image, a function in which a user writes a symbol, an arrow, a character, any writing, etc. on a display screen by a drawing input device etc. to combine the symbol etc. with the moving image and displays in real time can be balanced with a function in which the combined image is captured to be retained in a storage medium etc. and is displayed later. Then, interactive communication of drawing data in a teleconference can be implemented.

What is claimed is:

1. A drawing processing apparatus comprising:
an image control section for cutting out an image as static image information in a moving image from the moving image every predetermined time and extracting input drawing static information from a drawn input image every the predetermined time;
an image information storage section for storing the static image information in the moving image cut out by the image control section and the input drawing static information extracted by the image control section;
an image combining section for combining the static image information in the moving image and the input drawing static information stored in the image information storage section to create combined image information; and
an image drawing section for continuously outputting the combined image information.

2. The drawing processing apparatus according to claim 1, wherein the predetermined time is greater than or equal to a period between when the image control section cuts out a moving image and extracts input drawing static information and when the combined image information is displayed.

3. The drawing processing apparatus according to claim 1, wherein the image drawing section has a function of capturing the combined image information in response to an input of a screen capture signal by an image capture operation of a user.

4. The drawing processing apparatus according to claim 1, comprising:
a moving image storage section for storing a plurality of moving image data; and
a moving image reproducing section for fetching moving image data selected from the moving image data stored in the moving image storage section to reproduce moving images.

5. The drawing processing apparatus according to claim 1,
wherein the input drawing static information is a set of drawing data represented in a vector format, and
the image combining section combines an image based on the static image information in a moving image stored in the image information storage section with an image shown by the set of drawing data to create combined image information.

6. The drawing processing apparatus according to claim 5, wherein the drawing data includes data of color, size, points count and a coordinate data set of a drawn input image.

7. A drawing processing method comprising the steps of:
cutting out an image as static image information in a moving image from the moving image;
extracting input drawing static information from a drawn input image;
combining the static image information in the moving image obtained by the cutout and the input drawing static information obtained by the extraction to create combined image information; and
outputting the combined image information,
wherein the cutout of the static image information in the moving image and the extraction of the input drawing static information are repeated every predetermined time.

8. The drawing processing method according to claim 7, wherein the predetermined time is greater than or equal to a period between when the cutout of the static image information of the moving image and the extraction of the input drawing static information are performed and when the combined image information is displayed.

9. The drawing processing method according to claim 7, comprising a step of:
capturing the combined image information by a screen capture operation.

10. The drawing processing program, causing a computer to perform:
an image control function of cutting out an image as static image information in a moving image from the moving image every predetermined time and extracting input drawing static information from a drawn input image every the predetermined time; and
an image combining function of combining the static image information in the moving image cut out by the image control function and the input drawing static information extracted by the image control function to create combined image information.

11. A teleconference system in which a plurality of participant terminals which participate in a conference are connected through a communication line,
wherein a drawing processing apparatus comprising:
an image control section for cutting out an image as static image information in a moving image from the moving image every predetermined time and extracting input drawing static information from a drawn input image every the predetermined time;
an image information storage section for storing the static image information in the moving image cut out by the image control section and the input drawing static information extracted by the image control section;
an image combining section for combining the static image information in the moving image and the input drawing static information stored in the image information storage section to create combined image information; and
an image drawing section for continuously outputting the combined image information, is used as the participant terminal.
